(19) United States
(12) Patent Application Publication
(10) Pub. No.: US 2011/0006605 A1
(43) Pub. Date: Jan. 13, 2011

(54) CURRENT-SHARING SUPPLY CIRCUIT FOR DRIVING MULTIPLE SETS OF DC LOADS

(75) Inventors: Shih-Hsien Chang, Taoyuan Hsien (TW); Po-Nien Ko, Taoyuan Hsien (TW)

Correspondence Address: KIRTON AND MCCONKIE, 60 EAST SOUTH TEMPLE,, SUITE 1800, SALT LAKE CITY, UT, 84111, US

(73) Assignee: DELTA ELECTRONICS, INC., Taoyuan Hsien (TW)

(21) Appl. No.: 12/830,848

(22) Filed: Jul. 6, 2010

(30) Foreign Application Priority Data
Jul. 7, 2009 (TW) 098122992

(51) Int. Cl. H02J 1/00

(52) U.S. Cl. 307/31; 315/297

(57) ABSTRACT

A current-sharing supply circuit is provided for driving a first set of main DC loads, a first set of minor DC loads, a second set of main DC loads and a second set of minor DC loads. The current-sharing supply circuit includes a current providing circuit, a first output rectifier circuit, a second output rectifier circuit, a first main current-sharing circuit and a second main current-sharing circuit. By adjusting an equivalent impedance value of the first main current-sharing circuit to be impedance matched with that of the first set of main DC loads and that of the first set of minor DC loads, respectively, and adjusting an equivalent impedance value of the second main current-sharing circuit to be impedance matched with that of the second set of main DC loads and that of the second set of minor DC loads, respectively, a first main output current, a first minor output current, a second main output current and a second minor output current passing through these DC loads are substantially identical.

### FIELD OF THE INVENTION

The present invention relates to a current-sharing supply circuit, and more particularly to a current-sharing supply circuit for driving multiple sets of DC loads.

### BACKGROUND OF THE INVENTION

In recent years, light emitting diodes (LEDs) capable of emitting light with high luminance and high illuminating efficiency have been developed. In comparison with a common incandescent light, an LED has lower power consumption, long service life, and quick response speed. With the maturity of the LED technology, LEDs will replace all conventional lighting facilities. Until now, LEDs are widely used in many aspects of daily lives, such as automobile lighting devices, handheld lighting devices, backlight sources for LCD panels, traffic lights, indicator board displays, and the like.

Generally, the LED can be considered as a DC load. When an electronic device (e.g. an LCD panel) having multiple LED strings is operated, the currents passing through all LED strings shall be identical for a purpose of obtaining uniform brightness. Due to different inherent characteristics of these LED strings, the currents passing these LED strings are not identical and the brightness is usually not uniform. Therefore, the use life of individual LED string is shortened or even the whole electronic device has a breakdown.

For obtaining uniform brightness of multiple LED strings, several current-sharing techniques have been disclosed. For example, as shown in FIG. 1, U.S. Pat. No. 6,621,235 disclosed a current-sharing supply circuit for driving multiple LED strings. The current-sharing supply circuit of FIG. 1 principally includes a linear regulator 11, a low-pass filter 12 and multiple current mirrors M₁-Mₙ. A constant reference current I_{ref} is inputted into a first terminal of the linear regulator 11. The linear regulator 11 is controlled with the constant reference current I_{ref} and thus an output voltage is generated and transmitted to the low-pass filter 12. The output voltage is filtered by the low-pass filter 12 and then transmitted to the gates of the current mirrors M₁-Mₙ. As a consequence, these current mirrors M₁Mₙ outputs identical currents. In other words, the LED strings linked to the current mirrors M₁-Mₙ have the same current and brightness.

The conventional current-sharing supply circuit for driving multiple LED strings, however, still has some drawbacks. For example, since the linear regulator and the current mirrors are employed, the conventional current-sharing supply circuit has high power loss but low operating efficiency. In addition, since more components are used, the conventional current-sharing supply circuit is very complicated.

There is a need of providing an improved current-sharing supply circuit for driving multiple sets of DC loads to obviate the drawbacks encountered from the prior art.

### SUMMARY OF THE INVENTION

It is an object of the present invention to provide a current-sharing supply circuit for driving multiple sets of DC loads, in which the currents passing through all sets of DC loads are identical.

Another object of the present invention provides a current sharing supply circuit for driving multiple sets of DC loads, in which the current sharing supply circuit has minimized power loss, high operating efficiency and simplified circuitry configuration.

A further object of the present invention provides a current sharing supply circuit for driving multiple sets of DC loads, in which the overall volume of the current-sharing supply circuit is reduced but the circuitry density is enhanced.

In accordance with a first aspect of the present invention, there is provided a current-sharing supply circuit for driving a first set of main DC loads, a first set of minor DC loads, a second set of main DC loads and a second set of minor DC loads. The current-sharing supply circuit includes a current providing circuit, a first output rectifier circuit, a second output rectifier circuit, a first main current-sharing circuit and a second main current-sharing circuit. The current providing circuit is used for receiving an input voltage and generating a driving current or a driving voltage. The first main current-sharing circuit is serially connected with the first output rectifier circuit, the first set of main DC loads and output terminals of the current providing circuit, thereby collectively defining a first main current loop. The first main current-sharing circuit is serially connected with the first output rectifier circuit, the first set of minor DC loads and the output terminals of the current providing circuit, thereby collectively defining a first minor current loop. The second main current-sharing circuit is serially connected with the second output rectifier circuit, the second set of main DC loads and the output terminals of the current providing circuit, thereby collectively defining a second main current loop. The second main current-sharing circuit is serially connected with the second output rectifier circuit, the second set of minor DC loads and the output terminals of the current providing circuit, thereby collectively defining a second minor current loop. By adjusting an equivalent impedance value of the first main current-sharing circuit to be impedance matched with that of the first set of main DC loads and that of the first set of minor DC loads, respectively, and adjusting an equivalent impedance value of the second main current-sharing circuit to be impedance matched with that of the second set of main DC loads and that of the second set of minor DC loads, respectively, a first main output current passing through the first set of main DC loads, a first minor output current passing through the first set of minor DC loads, a second main output current passing through the second set of main DC loads and a second minor output current passing through the second set of minor DC loads are substantially identical.

The above contents of the present invention will become more readily apparent to those ordinarily skilled in the art after reviewing the following detailed description and accompanying drawings, in which:

### BRIEF DESCRIPTION OF THE DRAWINGS

FIG. 1 is a schematic circuit diagram of a current-sharing supply circuit for driving multiple LED strings according to the prior art;

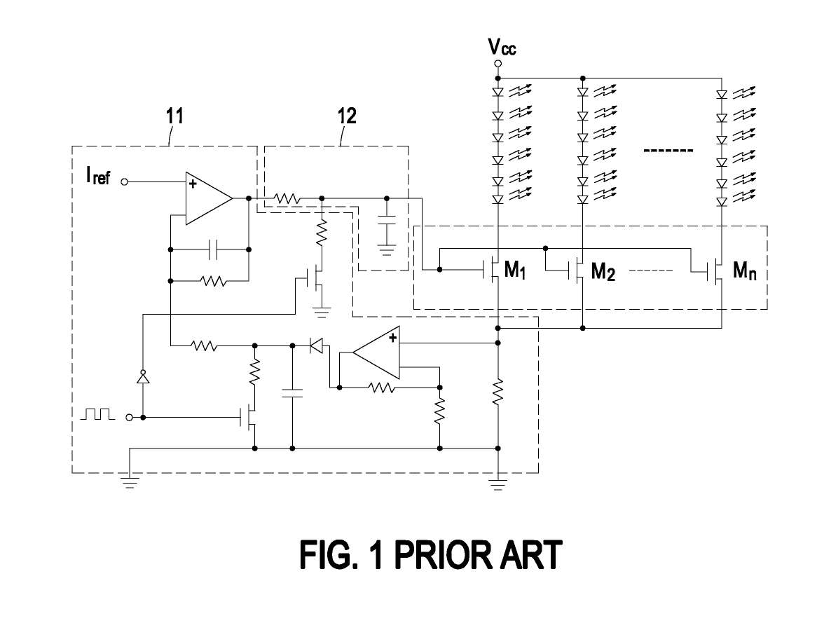

FIG. 2 is a schematic circuit block diagram of a current-sharing supply circuit for driving multiple sets of DC loads according to an embodiment of the present invention;

FIG. 3 is a schematic detailed circuit diagram illustrating the current-sharing supply circuit shown in FIG. 2;

FIG. 4 is a schematic detailed circuit diagram illustrating a variant of the current-sharing supply circuit shown in FIG. 3; and

FIG. 5 is a schematic detailed circuit diagram illustrating another variant of the current-sharing supply circuit shown in FIG. 3.

### DETAILED DESCRIPTION OF THE PREFERRED EMBODIMENT

The present invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

The present invention relates to a current-sharing supply circuit for driving multiple sets of DC loads, so that all sets of DC loads have the same brightness value. The multiple sets of DC loads include for example multiple LED strings. Each LED string includes a plurality of LEDs. For clarification, three or six LED strings, each of which has three LEDs, are shown in the drawings.

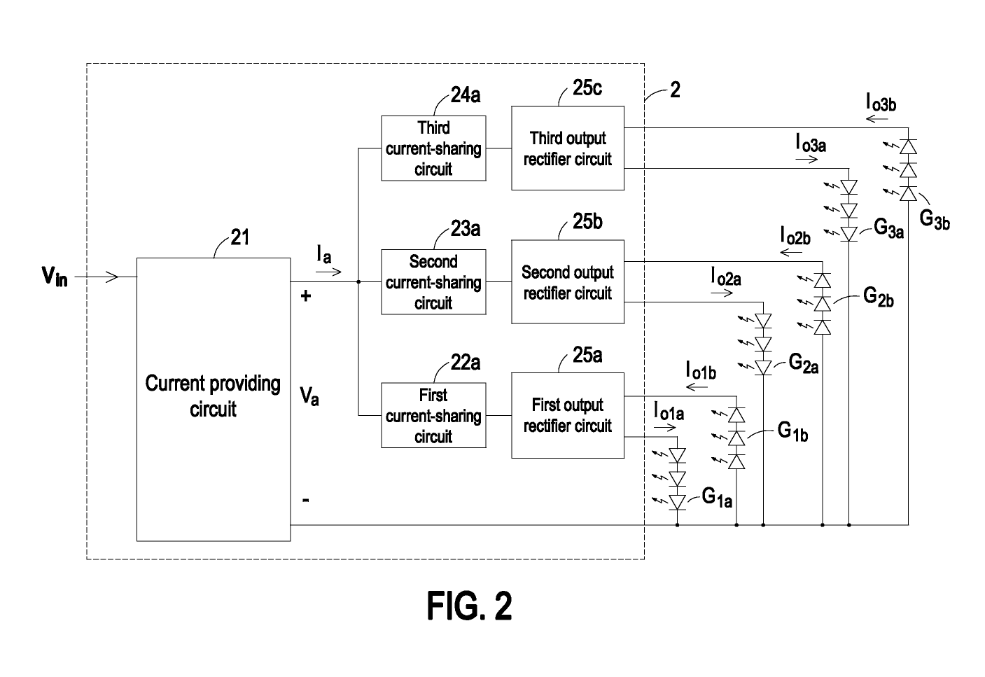

FIG. 2 is a schematic circuit block diagram of a current-sharing supply circuit for driving multiple sets of DC loads according to an embodiment of the present invention. The current-sharing supply circuit 2 is used for driving a first main LED string G₁ₐ, a first minor LED string G_{1b}, a second main LED string G₂ₐ, a second minor LED string G_{2b}, a third main LED string G₃ₐ and a third minor LED string G_{3b}. As shown in FIG. 2, the current-sharing supply circuit 2 comprises a current providing circuit 21, a first main current-sharing circuit 22a, a second main current-sharing circuit 23a, a third main current-sharing circuit 24a, a first output rectifier circuit 25a, a second output rectifier circuit 25b and a third output rectifier circuit 25c.

The current providing circuit 21 is used for receiving an input DC voltage Vᵢₙ and generating a driving current Iₐ or a driving voltage Vₐ. The first main current-sharing circuit 22a, the first output rectifier circuit 25a and the first main LED string G₁ₐ are serially connected with the output terminals of the current providing circuit 21, thereby collectively defining a first main current loop. The first main current-sharing circuit 22a, the first output rectifier circuit 25a and the first minor LED string G_{1b} are serially connected with the output terminals of the current providing circuit 21, thereby collectively defining a first minor current loop. The second main current-sharing circuit 23a, the second output rectifier circuit 25b and the second main LED string G₂ₐ are serially connected with the output terminals of the current providing circuit 21, thereby collectively defining a second main current loop. The second main current-sharing circuit 23a, the second output rectifier circuit 25b and the second minor LED string G_{2b} are serially connected with the output terminals of the current providing circuit 21, thereby collectively defining a second minor current loop. The third main current-sharing circuit 24a, the third output rectifier circuit 25c and the third main LED string G₃ₐ are serially connected with the output terminals of the current providing circuit 21, thereby collectively defining a third main current loop. The third main current-sharing circuit 24a, the third output rectifier circuit 25c and the third minor LED string G_{3b} are serially connected with the output terminals of the current providing circuit 21, thereby collectively defining a third minor current loop.

In addition, the driving current Iₐ or the driving voltage Vₐ that is in AC form and provided by the current providing circuit 21 is rectified by the first output rectifier circuit 25a, the second output rectifier circuit 25b and the third output rectifier circuit 25c. The rectified driving current Iₐ or the rectified driving voltage Vₐ is used for powering the first main LED string G₁ₐ, the first minor LED string G_{1b}, the second main LED string G₂ₐ, the second minor LED string G_{2b}, the third main LED string G₃ₐ and the third minor LED string G_{3b}.

In a case that the driving voltage Vₐ is at the positive potential, the electrical energy of the driving voltage Vₐ is transmitted to the first main LED string G₁ₐ, the second main LED string G₂ₐ and the third main LED string G₃ₐ through the first main current loop, the second main current loop and the third main current loop, respectively, thereby driving illumination of the first main LED string G₁ₐ, the second main LED string G₂ₐ and the third main LED string G₃ₐ. At the same time, a first main output current Io₁ₐ passing through the first main LED string G₁ₐ, a second main output current Io₁ₐ passing through the second main LED string G₂ₐ and a third main output current Io₃ₐ passing through the third main LED string G₃ₐ are not zero. In addition, the magnitudes of the first minor output current Io_{1b}, the second minor output current Io_{2b} and the third minor output current Io_{3b} are zero.

Whereas, in a case that the driving voltage Vₐ is at the negative potential, the electrical energy of the driving voltage Vₐ is transmitted to the first minor LED string G_{1b}, the second minor LED string G_{2b} and the third minor LED string G_{3b} through the first minor current loop, the second minor current loop and the third minor current loop, respectively, thereby driving illumination of the first minor LED string G_{1b}, the second minor LED string G_{2b} and the third minor LED string G_{3b}. At the same time, the first minor output current Io_{1b} passing through the first minor LED string G_{1b}, the second minor output current Io_{2b} passing through the second minor LED string G_{2b} and the third minor output current Io_{3b} passing through the third minor LED string G_{3b} are not zero. In addition, the magnitudes of the first main output current Io₁ₐ, the second main output current Io₂ₐ and the third main output current Io₃ₐ are zero.

In the first main current loop, the magnitude of the first main output current Io₁ₐ is dependent on the sum of the equivalent impedance value of the first main current-sharing circuit 22a and the equivalent impedance value of the first main LED string G₁ₐ. In the first minor current loop, the magnitude of the first minor output current Io_{1b} is dependent on the sum of the equivalent impedance value of the first main current-sharing circuit 22a and the equivalent impedance value of the first minor LED string G_{1b}. In the second main current loop, the magnitude of the second main output current Io₂ₐ is dependent on the sum of the equivalent impedance value of the second main current-sharing circuit 23a and the equivalent impedance value of the second main LED string G₂ₐ. In the second minor current loop, the magnitude of the second minor output current Io_{2b} is dependent on the sum of the equivalent impedance value of the second main current-sharing circuit 23a and the equivalent impedance value of the second minor LED string G_{2b}. In the third main current loop, the magnitude of the third main output current Io₃ₐ is dependent on the sum of the equivalent impedance value of the third main current-sharing circuit 24a and the equivalent impedance value of the third main LED string G₃ₐ. In the third minor current loop, the magnitude of the third minor output current Io_{3b} is dependent on the sum of the equivalent impedance value of the third main current-sharing circuit 24a and the equivalent impedance value of the third minor LED string G_{3b}.

Therefore, by adjusting the first main current-sharing circuit 22a, the second main current-sharing circuit 23a and the third main current-sharing circuit 24a, the sum of the equivalent impedance value of the first main current-sharing circuit 22a and the equivalent impedance value of the first main LED string G₁ₐ, the sum of the equivalent impedance value of the first main current-sharing circuit 22a and the equivalent impedance value of the first minor LED string G_{1b}, the sum of the equivalent impedance value of the second main current-sharing circuit 23a and the equivalent impedance value of the second main LED string G₂ₐ, the sum of the equivalent impedance value of the second main current-sharing circuit 23a and the equivalent impedance value of the second minor LED string G_{2b}, the sum of the equivalent impedance value of the third main current-sharing circuit 24a and the equivalent impedance value of the third main LED string G₃ₐ and the sum of the equivalent impedance value of the third main current-sharing circuit 24a and the equivalent impedance value of the third minor LED string G_{3b} are substantially identical.

Even if the impedance properties of the first main LED string G₁ₐ, the first minor LED string G_{1b}, the second main LED string G₂ₐ, the second minor LED string G_{2b}, the third main LED string G₃ₐ and the third minor LED string G_{3b} are different, by adjusting the equivalent impedance value of the first main current-sharing circuit 22a to be impedance matched with the equivalent impedance values of the first main LED string G₁ₐ and the first minor LED string G_{1b}, respectively, adjusting the equivalent impedance value of the second main current-sharing circuit 23a to be impedance matched with the equivalent impedance values of the second main LED string G₂ₐ and the second minor LED string G_{2b}, respectively, and adjusting the equivalent impedance value of the third main current-sharing circuit 24a to be impedance matched with the equivalent impedance values of the third main LED string G₃ₐ and the third minor LED string G_{3b}, respectively, the magnitudes of the first main output current Io₁ₐ, the first minor output current Io_{1b}, the second main output current Io₂ₐ, the second minor output current Io_{2b}, the third main output current Io₃ₐ and the third minor output current Io_{3b} are substantially identical. As such, all LED strings have the same brightness value.

As known, for different LEDs, the relations between the brightness values and the currents are somewhat different. Generally, if the differences between the first main output current Io₁ₐ, the first minor output current Io_{1b}, the second main output current Io₂ₐ, the second minor output current Io_{2b}, the third main output current Io₃ₐ and the third minor output current Io_{3b} are in the range of from −10% to +10%, the brightness differences between the first main LED string G₁ₐ, the first minor LED string G_{1b}, the second main LED string G₂ₐ, the second minor LED string G_{2b}, the third main LED string G₃ₐ and the third minor LED string G_{3b} are very tiny. In this context, the first main output current Io₁ₐ, the first minor output current Io_{1b}, the second main output current Io₂ₐ, the second minor output current Io_{2b}, the third main output current Io₃ₐ and the third minor output current Io_{3b} are considered to be substantially identical if the difference between the first main output current Io₁ₐ, the first minor output current Io_{1b}, the second main output current Io₂ₐ, the second minor output current Io_{2b}, the third main output current Io₃ₐ and the third minor output current Io_{3b} is in the range of from −10% to +10%. In some embodiments where the brightness variation is relative large, the first main output current Io₁ₐ, the first minor output current Io_{1b}, the second main output current Io₂ₐ, the second minor output current Io_{2b}, the third main output current Io₃ₐ and the third minor output current Io_{3b} are considered to be substantially identical if the differences between the first main output current Io₁ₐ, the first minor output current Io_{1b}, the second main output current Io₂ₐ, the second minor output current Io_{2b}, the third main output current Io₃ₐ and the third minor output current Io_{3b} are in the range of from −5% to +5%.

In the first main current loop and the first minor current loop, the equivalent impedance value of the first main current-sharing circuit 22a is greater than the equivalent impedance value of each of the first main LED string G₁ₐ and the first minor LED string G_{1b}. As such, the first main output current Io₁ₐ of the first main current loop and the first minor output current Io_{1b} of the first minor current loop are respectively dependent on the equivalent impedance value of the first main current-sharing circuit 22a. In the second main current loop and the second minor current loop, the equivalent impedance value of the second main current-sharing circuit 23a is greater than the equivalent impedance value of each of the second main LED string G₂a and the second minor LED string G_{2b}. As such, the second main output current Io₂ₐ of the second main current loop and the second minor output current Io_{2b} of the second minor current loop are respectively dependent on the equivalent impedance value of the second main current-sharing circuit 23a. In the third main current loop and the third minor current loop, the equivalent impedance value of the third main current-sharing circuit 24a is greater than the equivalent impedance value of each of the third main LED string G₃ₐ and the third minor LED string G_{3b}. As such, the third main output current Io₃ₐ of the third main current loop and the third minor output current Io_{3b} of the third minor current loop are respectively dependent on the equivalent impedance value of the third main current-sharing circuit 24a.

In an embodiment, the equivalent impedance value of the first main current-sharing circuit 22a is more than ten times of the equivalent impedance value of each of the first main LED string G₁ₐ and the first minor LED string G_{1b}. Similarly, the equivalent impedance value of the second main current-sharing circuit 23a is more than ten times of the equivalent impedance value of each of the second main LED string G₂ₐ and the second minor LED string G_{2b}. Similarly, the equivalent impedance value of the third main current-sharing circuit 24a is more than ten times of the equivalent impedance value of each of the third main LED string G₃ₐ and the third minor LED string G_{3b}. As a consequence, even if the impedance properties of the first main LED string G₁ₐ, the first minor LED string G_{1b}, the second main LED string G₂ₐ, the second minor LED string G_{2b}, the third main LED string G₃ₐ and the third minor LED string G_{3b} are different, the magnitudes of the first main output current Io₁ₐ, the first minor output current Io_{1b}, the second main output current Io₂ₐ, the second minor output current Io_{2b}, the third main output current Io₃ₐ and the third minor output current Io_{3b} are substantially identical. As such, all LED strings have the same brightness value.

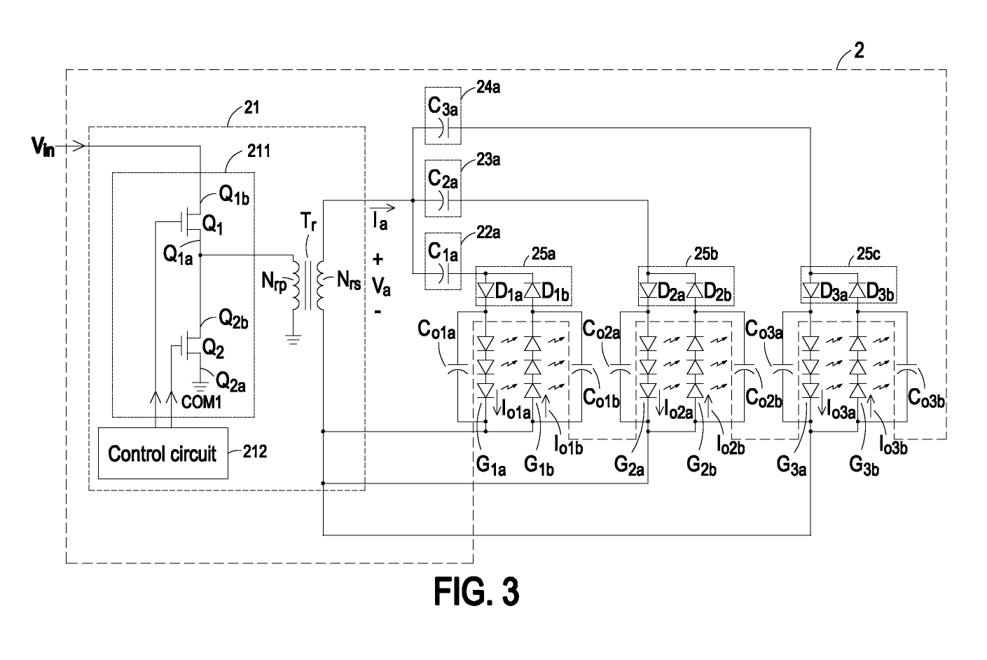

FIG. 3 is a schematic detailed circuit diagram illustrating the current-sharing supply circuit shown in FIG. 2. The current providing circuit 21 comprises a switching circuit 211, a control circuit 212 and an isolation transformer Tᵣ. The power output terminal of the switching circuit 211 is connected with a primary winding coil Nᵣₚ of the isolation transformer Tᵣ. The control terminal of the switching circuit 211 is connected with the control circuit 212. The electrical energy of the input DC voltage Vᵢₙ is selectively transmitted to the primary winding coil Nᵣₚ of the isolation transformer Tᵣ through the switching circuit 211 according to a first pulse width modulation signal V_{PWM1} and a second pulse width modulation signal V_{PWM2} that are outputted from the control circuit 212.

In this embodiment, the switching circuit 211 comprises a first switch element Q₁ and a second switch element Q₂. A first end Q₁ₐ of the first switch element Q₁ is connected with a first end of the primary winding coil Nᵣₚ and a second end Q_{2b} of the second switch element Q₂. A first end Q₂ₐ of the second switch element Q₂ is connected with a first common terminal COM₁. The second end of the primary winding coil Nᵣₚ is also connected with the first common terminal COM₁. The control terminals of the first switch element Q₁ and the second switch element Q₂ are connected with the control circuit 212. Under control of the control circuit 212, the first switch element Q₁ and the second switch element Q₂ are selectively conducted or shut off according to the first pulse width modulation signal V_{PWM1} and the second pulse width modulation signal V_{PWM2}, respectively. As a consequence, the electrical energy of the input DC voltage Vᵢₙ is selectively transmitted to the primary winding coil Nᵣₚ of the isolation transformer Tᵣ through the second end Q_{1b} of the first switch element Q₁ or the first end Q₂ₐ of the second switch element Q₂. As such, both ends of the primary winding coil Nᵣₚ of the isolation transformer Tᵣ are subject to a voltage variation. Due to the voltage variation, a secondary winding coil Nᵣₛ of the isolation transformer Tᵣ generates the driving current Iₐ or the driving voltage Vₐ.

In this embodiment, the first output rectifier circuit 25a comprises a first main diode D₁ₐ and a first minor diode D_{1b}, the second output rectifier circuit 25b comprises a second main diode D₂ₐ and a second minor diode D_{2b}, and the third output rectifier circuit 25c comprises a third main diode D₃ₐ and a third minor diode D_{3b}. The first current-sharing circuit 22a comprises a first capacitive passive element (e.g. a first main capacitor C₁ₐ). The second current-sharing circuit 23a comprises a second capacitive passive element (e.g. a second main capacitor C₂ₐ). The third current-sharing circuit 24a comprises a third capacitive passive element (e.g. a third main capacitor C₃ₐ). The first main capacitor C₁ₐ, the first main diode D₁ₐ and the first main LED string G₁ₐ are serially connected with the output terminals of the current providing circuit 21, thereby collectively defining the first main current loop. The first main capacitor C₁ₐ, the first minor diode D_{1b} and the first minor LED string G_{1b} are serially connected with the output terminals of the current providing circuit 21, thereby collectively defining the first minor current loop. The second main capacitor C₂ₐ, the second main diode D₂ₐ and the second main LED string G₂ₐ are serially connected with the output terminals of the current providing circuit 21, thereby collectively defining the second main current loop. The second main capacitor C₂ₐ, the second minor diode D_{2b} and the second minor LED string G_{2b} are serially connected with the output terminals of the current providing circuit 21, thereby collectively defining the second minor current loop. The third main capacitor C₃ₐ, the third main diode D₃ₐ and the third main LED string G₃ₐ are serially connected with the output terminals of the current providing circuit 21, thereby collectively defining the third main current loop. The third main capacitor C₃ₐ, the third minor diode D_{3b} and the third minor LED string G_{3b} are serially connected with the output terminals of the current providing circuit 21, thereby collectively defining the third minor current loop.

Since the first main current-sharing circuit 22a, the second main current-sharing circuit 23a and the third main current-sharing circuit 24a are capacitive impedances, the capacitance value of any of the first main current-sharing circuit 22a, the second main current-sharing circuit 23a and the third main current-sharing circuit 24a could be adjusted without power consumption. Under this circumstance, the magnitudes of the first main output current Io₁ₐ, the first minor output current Io_{1b}, the second main output current Io₂ₐ, the second minor output current Io_{2b}, the third main output current Io₃ₐ and the third minor output current Io_{3b} are adjustable.

In the first main current loop and the first minor current loop, the equivalent impedance value of the first main current-sharing circuit 22a is greater than the equivalent impedance value of each of the first main LED string G₁ₐ and the first minor LED string G_{1b}. As such, the first main output current Io₁ₐ of the first main current loop and the first minor output current Io_{1b} of the first minor current loop are respectively dependent on the equivalent impedance value of the first main current-sharing circuit 22a. In the second main current loop and the second minor current loop, the equivalent impedance value of the second main current-sharing circuit 23a is greater than the equivalent impedance value of each of the second main LED string G₂ₐ and the second minor LED string G_{2b}. As such, the second main output current Io₂ₐ of the second main current loop and the second minor output current Io_{2b} of the second minor current loop are respectively dependent on the equivalent impedance value of the second main current-sharing circuit 23a. In the third main current loop and the third minor current loop, the equivalent impedance value of the third main current-sharing circuit 24a is greater than the equivalent impedance value of each of the third main LED string G₃ₐ and the third minor LED string G_{3b}. As such, the third main output current Io₃ₐ of the third main current loop and the third minor output current Io_{3b} of the third minor current loop are respectively dependent on the equivalent impedance value of the third main current-sharing circuit 24a.

In an embodiment, the equivalent impedance value of the first main current-sharing circuit 22a is more than ten times of the equivalent impedance value of each of the first main LED string G₁ₐ and the first minor LED string G_{1b}. Similarly, the equivalent impedance value of the second main current-sharing circuit 23a is more than ten times of the equivalent impedance value of each of the second main LED string G₂ₐ and the second minor LED string G_{2b}. Similarly, the equivalent impedance value of the third main current-sharing circuit 24a is more than ten times of the equivalent impedance value of each of the third main LED string G₃ₐ and the third minor LED string G_{3b}. As a consequence, even if the impedance properties of the first main LED string G₁ₐ, the first minor LED string G_{1b}, the second main LED string G₂ₐ, the second minor LED string G_{2b}, the third main LED string G₃ₐ and the third minor LED string G_{3b} are different, the magnitudes of the first main output current Io₁ₐ, the first minor output current Io_{1b}, the second main output current Io₂ₐ, the second minor output current Io_{2b}, the third main output current Io₃ₐ and the third minor output current Io_{3b} are substantially identical. As such, all LED strings have the same brightness value.

In this embodiment, the current-sharing supply circuit 2 further comprises a first main output capacitor Cₒ₁ₐ, a first minor output capacitor C_{o1b}, a second main output capacitor Cₒ₂ₐ, a second minor output capacitor C_{o2b}, a third main output capacitor Cₒ₃ₐ and a third minor output capacitor C_{o3b}. The first main output capacitor Cₒ₁ₐ is connected with the first main LED string G₁ₐ in parallel for filtering, thereby enabling the first main output current Io₁ₐ to have better DC property. The first minor output capacitor C_{o1b} is connected with the first minor LED string G_{1b} in parallel for filtering, thereby enabling the first minor output current Io_{1b} to have better DC property. The second main output capacitor Cₒ₁ₐ is connected with the second main LED string G₂ₐ in parallel for filtering, thereby enabling the second main output current Io₂ₐ to have better DC property. The second minor output capacitor C_{o2b} is connected with the second minor LED string G_{2b} in parallel for filtering, thereby enabling the second minor output current Io_{2b} to have better DC property. The third main output capacitor Cₒ₃ₐ is connected with the third main LED string G₃ₐ in parallel for filtering, thereby enabling the third main output current Io₃ₐ to have better DC property. The third minor output capacitor C_{o3b} is connected with the third minor LED string G_{3b} in parallel for filtering, thereby enabling the third minor output current Io_{3b} to have better DC property.

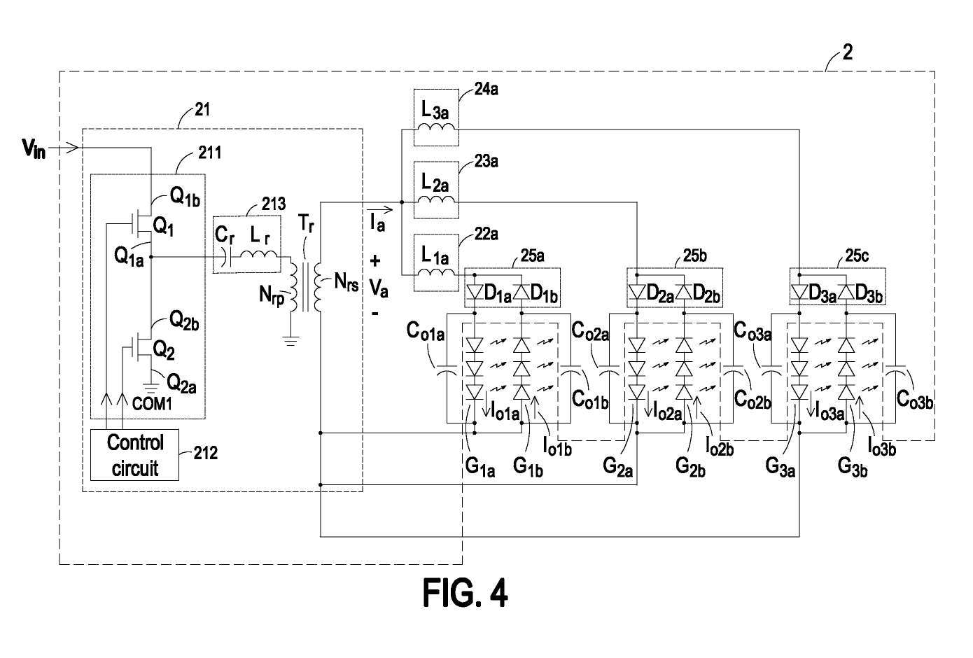

FIG. 4 is a schematic detailed circuit diagram illustrating a variant of the current-sharing supply circuit shown in FIG. 3. In comparison with FIG. 3, the first current-sharing circuit 22a comprises a first inductive passive element (e.g. a first main inductor L₁ₐ), the second current-sharing circuit 23a comprises a second inductive passive element (e.g. a second main inductor L₂ₐ), the third current-sharing circuit 24a comprises a third inductive passive element (e.g. a third main inductor L₃ₐ), and the current providing circuit 21 further comprises a resonant circuit 213. The resonant circuit 213 is interconnected between the primary winding coil Nᵣₚ of the isolation transformer Tᵣ and the switching circuit 211. The resonant circuit 213 includes a resonant capacitor Cᵣ and a resonant inductor Lᵣ. The resonant capacitor Cᵣ and the resonant inductor Lᵣ are serially connected with the primary winding coil Nᵣₚ of the isolation transformer Tᵣ. Since the first main current-sharing circuit 22a, the second main current-sharing circuit 23a and the third main current-sharing circuit 24a are inductive impedances, the inductance value of any of the first main current-sharing circuit 22a, the second main current-sharing circuit 23a and the third main current-sharing circuit 24a could be adjusted without power consumption. Under this circumstance, the magnitudes of the first main output current Io₁ₐ, the first minor output current Io_{1b}, the second main output current Io₂ₐ, the second minor output current Io_{2b}, the third main output current Io₃ₐ and the third minor output current Io_{3b} are adjustable.

In accordance with the present invention, a resonant relation is created between the primary winding coil Nᵣₚ of the isolation transformer Tᵣ and the resonant circuit 213. The isolation transformer Tᵣ is designed to create a resonant relation between the primary winding coil Nᵣₚ of the isolation transformer Tᵣ and the resonant circuit 213. The resonant frequency is for example 30 kHz. The resonant relation between the isolation transformer Tᵣ and the resonant circuit 213 has nothing to do with the impedance properties of the first main LED string G₁ₐ, the first minor LED string G_{1b}, the second main LED string G₂ₐ, the second minor LED string G_{2b}, the third main LED string G₃ₐ and the third minor LED string G_{3b}. In other words, the structure of the isolation transformer Tᵣ could be as simple as possible. Since the overall volume of the current-sharing supply circuit 2 is reduced but the circuitry density is enhanced, the current-sharing supply circuit 2 is feasible to be used in small-sized electronic devices (e.g. slim-type TV sets, slim-type screens or slim-type notebook computer) that have LEDs as backlight sources.

In an embodiment of FIG. 4, the equivalent impedance value of the first main current-sharing circuit 22a is more than ten times of the equivalent impedance value of each of the first main LED string G₁ₐ and the first minor LED string G_{1b}. Similarly, the equivalent impedance value of the second main current-sharing circuit 23a is more than ten times of the equivalent impedance value of each of the second main LED string G₂ₐ and the second minor LED string G_{2b}. Similarly, the equivalent impedance value of the third main current-sharing circuit 24a is more than ten times of the equivalent impedance value of each of the third main LED string G₃ₐ and the third minor LED string G_{3b}. As a consequence, even if the impedance properties of the first main LED string G₁ₐ, the first minor LED string G_{1b}, the second main LED string G₂ₐ, the second minor LED string G_{2b}, the third main LED string G₃ₐ and the third minor LED string G_{3b} are different, the magnitudes of the first main output current Io₁ₐ, the first minor output current Io_{1b}, the second main output current Io₂ₐ, the second minor output current Io_{2b}, the third main output current Io₃ₐ and the third minor output current Io_{3b} are substantially identical. As such, all LED strings have the same brightness value.

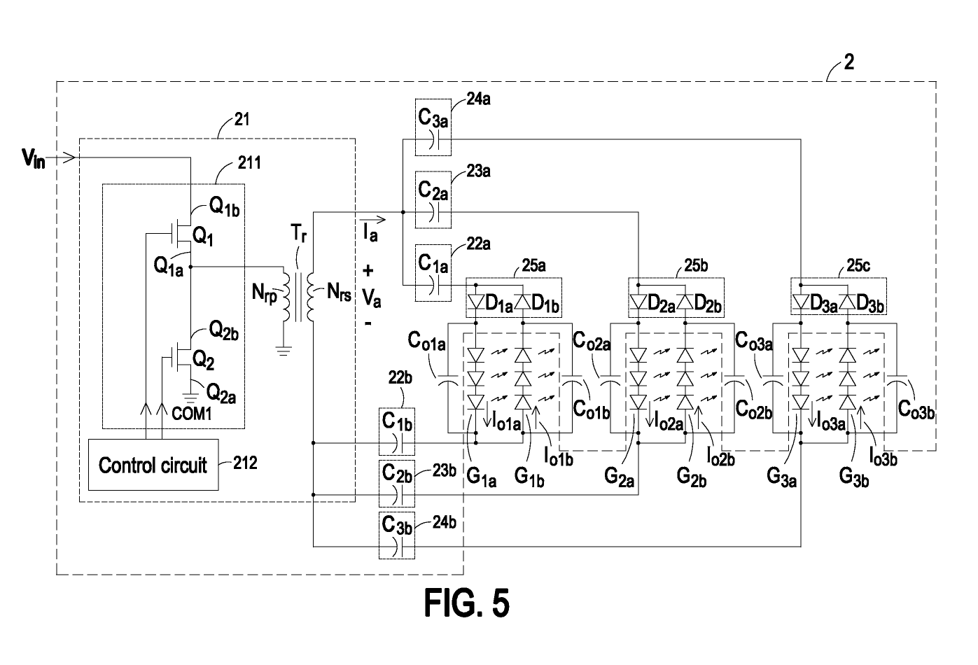

FIG. 5 is a schematic detailed circuit diagram illustrating another variant of the current-sharing supply circuit shown in FIG. 3. In comparison with FIG. 3, the current-sharing supply circuit 2 of FIG. 5 further comprises a first minor current-sharing circuit 22b, a second minor current-sharing circuit 23b and a third minor current-sharing circuit 24b. The first minor current-sharing circuit 22b comprises a first capacitive passive element (e.g. a first minor capacitor C_{1b}). The second minor current-sharing circuit 23b comprises a second capacitive passive element (e.g. a second minor capacitor C_{2b}). The third current-sharing circuit 24b comprises a third capacitive passive element (e.g. a third minor capacitor C_{3b}). In this embodiment, the first output rectifier circuit 25a comprises a first main diode D₁ₐ and a first minor diode D_{1b}, the second output rectifier circuit 25b comprises a second main diode D₂ₐ and a second minor diode D_{2b}, and the third output rectifier circuit 25c comprises a third main diode D₃ₐ and a third minor diode D_{3b}.

The first main diode D₁ₐ and the first main LED string G₁ₐ are serially connected with each other. The first minor diode D_{1b} and the first minor LED string G_{1b} are serially connected with each other. The anode of the first main diode D₁ₐ is connected with the cathode of the first minor diode D_{1b}. Alternatively, the cathode of the first main diode D₁ₐ is connected with the anode of the first minor diode D_{1b}. The first main capacitor C₁ₐ, the first main diode D₁ₐ, the first main LED string G₁ₐ and the first minor capacitor C_{1b} are serially connected with the output terminals of the current providing circuit 21, thereby collectively defining the first main current loop. The first main capacitor C₁ₐ, the first minor diode D_{1b}, the first minor LED string G_{1b} and the first minor capacitor C_{1b} are serially connected with the output terminals of the current providing circuit 21, thereby collectively defining the first minor current loop.

Similarly, the second main diode D₂ₐ and the second main LED string G₂ₐ are serially connected with each other. The second minor diode D_{2b} and the second minor LED string G_{2b} are serially connected with each other. The anode of the second main diode D₂ₐ is connected with the cathode of the second minor diode D_{2b}. Alternatively, the cathode of the second main diode D₂ₐ is connected with the anode of the second minor diode D_{2b}. The second main capacitor C₂ₐ, the second main diode D₂ₐ, the second main LED string G₂ₐ and the second minor capacitor C_{2b} are serially connected with the output terminals of the current providing circuit 21, thereby collectively defining the second main current loop. The second main capacitor C₂ₐ, the second minor diode D_{2b}, the second minor LED string G_{2b} and the second minor capacitor C_{2b} are serially connected with the output terminals of the current providing circuit 21, thereby collectively defining the second minor current loop.

Similarly, the third main diode D₃ₐ and the third main LED string G₃ₐ are serially connected with each other. The third minor diode D_{3b} and the third minor LED string G_{3b} are serially connected with each other. The anode of the third main diode D₃ₐ is connected with the cathode of the third minor diode D_{3b}. Alternatively, the cathode of the third main diode D₃ₐ is connected with the anode of the third minor diode D_{3b}. The third main capacitor C₃ₐ, the third main diode D₃ₐ, the third main LED string G₃ₐ and the third minor capacitor C_{3b} are serially connected with the output terminals of the current providing circuit 21, thereby collectively defining the third main current loop.

The third main capacitor C₃ₐ, the third minor diode D_{3b}, the third minor LED string G_{3b} and the third minor capacitor C_{3b} are serially connected with the output terminals of the current providing circuit 21, thereby collectively defining the third minor current loop.

In a case that the driving voltage Vₐ is at the positive potential, the electrical energy of the driving voltage Vₐ is transmitted to the first main LED string G₁ₐ, the second main LED string G₂ₐ and the third main LED string G₃ₐ through the first main current loop, the second main current loop and the third main current loop, respectively, thereby driving illumination of the first main LED string G₁ₐ, the second main LED string G₂ₐ and the third main LED string G₃ₐ. At the same time, a first main output current Io₁ₐ passing through the first main LED string G₁ₐ, a second main output current Io₂ₐ passing through the second main LED string G₂ₐ and a third main output current Io₃ₐ passing through the third main LED string G₃ₐ are not zero. In addition, the magnitudes of the first minor output current Io_{1b}, the second minor output current Io_{2b} and the third minor output current Io_{3b} are zero.

Whereas, in a case that the driving voltage Vₐ is at the negative potential, the electrical energy of the driving voltage Vₐ is transmitted to the first minor LED string G_{1b}, the second minor LED string G_{2b} and the third minor LED string G_{3b} through the first minor current loop, the second minor current loop and the third minor current loop, respectively, thereby driving illumination of the first minor LED string G_{1b}, the second minor LED string G₂b and the third minor LED string G_{3b}. At the same time, the first minor output current Io_{1b} passing through the first minor LED string G_{1b}, the second minor output current Io_{2b} passing through the second minor LED string G_{2b} and the third minor output current Io_{3b} passing through the third minor LED string G_{3b} are not zero. In addition, the magnitudes of the first main output current Io₁ₐ, the second main output current Io₂ₐ and the third main output current Io₃ₐ are zero.

In the first main current loop and the first minor current loop, the serial equivalent impedance value of the serially-connected current-sharing circuits 22a and 22b is more than ten times of the equivalent impedance value of each of the first main LED string G₁ₐ and the first minor LED string G_{1b}. As such, the first main output current Io₁ₐ of the first main current loop and the first minor output current Io_{1b} of the first minor current loop are respectively dependent on the sum of the equivalent impedance value of the first main current-sharing circuit 22a and the equivalent impedance value of the first minor current-sharing circuit 22b. In the second main current loop and the second minor current loop, the serial equivalent impedance value of the serially-connected current-sharing circuits 23a and 23b is more than ten times of the equivalent impedance value of each of the second main LED string G₂ₐ and the second minor LED string G_{2b}. As such, the second main output current Io₂ₐ of and the second main current loop and the second minor output current Io_{2b} of the second minor current loop are respectively dependent on the sum of the equivalent impedance value of the second main current-sharing circuit 23a and the equivalent impedance value of the second minor current-sharing circuit 23b. In the third main current loop and the third minor current loop, the serial equivalent impedance value of the serially-connected current-sharing circuits 24a and 24b is more than ten times of the equivalent impedance value of each of the third main LED string G₃ₐ and the third minor LED string G_{3b}. As such, the third main output current Io₃ₐ of and the third main current loop and the third minor output current Io_{3b} of the third minor current loop are respectively dependent on the sum of the equivalent impedance value of the third main current-sharing circuit 24a and the equivalent impedance value of the third minor current-sharing circuit 24b. As a consequence, even if the impedance properties of the first main LED string G₁ₐ, the first minor LED string G_{1b}, the second main LED string G₂ₐ, the second minor LED string G_{2b}, the third main LED string G₃ₐ and the third minor LED string G_{3b} are different, the magnitudes of the first main output current Io₁ₐ, the first minor output current Io_{1b}, the second main output current Io₂ₐ, the second minor output current Io_{2b}, the third main output current Io₃ₐ and the third minor output current Io_{3b} are substantially identical. As such, all LED strings have the same brightness value.

In some embodiments, the sum of the equivalent impedance value in the first main current loop, the sum of the equivalent impedance value in the first minor current loop, the sum of the equivalent impedance value in the second main current loop, the sum of the equivalent impedance value in the second minor current loop, the sum of the equivalent impedance value in the third main current loop and the sum of the equivalent impedance value in the third minor current loop are identical by adjusting the first main current-sharing circuit 22a, the first minor current-sharing circuit 22b, the second main current-sharing circuit 23a, the second minor current-sharing circuit 23b, the third main current-sharing circuit 24a and the third minor current-sharing circuit 24b. Under this circumstance, the magnitudes of the first main output current Io₁ₐ, the first minor output current Io_{1b}, the second main output current Io₂ₐ, the second minor output current Io_{2b}, the third main output current Io₃ₐ and the third minor output current Io_{3b} are substantially identical. As such, all LED strings have the same brightness value.

In the above embodiments, an example of the first switch element Q₁ or the second switch element Q₂ includes but is not limited to a metal oxide semiconductor field effect transistor (MOSFET) or a bipolar junction transistor (BJT). An example of the control circuit 212 includes but is not limited to a digital signal processor (DSP), a micro processor, a pulse width modulation (PWM) controller, or a pulse frequency modulation (PFM) controller. An example of each output rectifier circuit includes but is not limited to a bridge rectifier circuit, a full-wave rectifier circuit or a half-wave rectifier circuit.

From the above, the current-sharing supply circuit of the present invention is capable of balancing the currents passing through all sets of DC loads and thus all sets of DC loads have the same brightness value. In addition, since the circuitry configuration is simplified, the current-sharing supply circuit of the present invention has reduced number of components, reduced manufacturing cost, reduced power loss and high operating efficiency. Since the overall volume of the current-sharing supply circuit is reduced but the circuitry density is enhanced, the current-sharing supply circuit is feasible to be used in small-sized electronic devices (e.g. slim-type TV sets, slim-type screens or slim-type notebook computer) that have LEDs as backlight sources.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A current-sharing supply circuit for driving a first set of main DC loads, a first set of minor DC loads, a second set of main DC loads and a second set of minor DC loads, said current-sharing supply circuit comprising:
a current providing circuit for receiving an input voltage and generating a driving current or a driving voltage;
a first output rectifier circuit for rectification;
a second output rectifier circuit for rectification;
a first main current-sharing circuit serially connected with said first output rectifier circuit, said first set of main DC loads and output terminals of said current providing circuit, thereby collectively defining a first main current loop, and serially connected with said first output rectifier circuit, said first set of minor DC loads and said output terminals of said current providing circuit, thereby collectively defining a first minor current loop; and
a second main current-sharing circuit serially connected with said second output rectifier circuit, said second set of main DC loads and said output terminals of said current providing circuit, thereby collectively defining a second main current loop, and serially connected with said second output rectifier circuit, said second set of minor DC loads and said output terminals of said current providing circuit, thereby collectively defining a second minor current loop,
wherein a first main output current passing through said first set of main DC loads, a first minor output current passing through said first set of minor DC loads, a second main output current passing through said second set of main DC loads and a second minor output current passing through said second set of minor DC loads are substantially identical by adjusting an equivalent impedance value of said first main current-sharing circuit to be impedance matched with that of said first set of main DC loads and that of said first set of minor DC loads, respectively, and adjusting an equivalent impedance value of said second main current-sharing circuit to be impedance matched with that of said second set of main DC loads and that of said second set of minor DC loads, respectively.

2. The current-sharing supply circuit according to claim 1 wherein each of said first main current-sharing circuit and said second main current-sharing circuit comprises a capacitive passive element.

3. The current-sharing supply circuit according to claim 2 wherein said first main current-sharing circuit and said second main current-sharing circuit comprises a first main capacitor and a second main capacitor, respectively.

4. The current-sharing supply circuit according to claim 1 wherein each of said first main current-sharing circuit and said second main current-sharing circuit comprises an inductive passive element.

5. The current-sharing supply circuit according to claim 4 wherein said first main current-sharing circuit and said second main current-sharing circuit comprises a first main inductor and a second main inductor, respectively.

6. The current-sharing supply circuit according to claim 1 wherein said current providing circuit comprises:
an isolation transformer having a secondary winding coil connected with an output terminal of said current providing circuit;
a switching circuit having a power output terminal connected with a primary winding coil of said isolation transformer; and
a control circuit connected with a control terminal of said switching circuit for generating at least a first pulse width modulation signal for controlling operations of said switching circuit, wherein electrical energy of said input voltage is selectively transmitted to said primary winding coil of said isolation transformer through said switching circuit according to said first pulse width modulation signal.

7. The current-sharing supply circuit according to claim 6 wherein said switching circuit comprises:
a first switch element having a first end connected with a first end of said primary winding coil of said isolation transformer, and a control terminal connected with said control circuit; and
a second switch element having a second end connected with said first end of said primary winding coil of said isolation transformer and said first end of said first switch element, a first end connected with a second end of said primary winding coil of said isolation transformer, and a control terminal connected with said control circuit, wherein said second switch element is selectively conducted or shut off according to a second pulse width modulation signal generated by said control circuit,
wherein under control of said control circuit, said first switch element and said second switch element are selectively conducted or shut off according to said first pulse width modulation signal and said second pulse width modulation signal, so that electrical energy of said input voltage is selectively transmitted to said primary winding coil of said isolation transformer through said first switch element or said second switch element.

8. The current-sharing supply circuit according to claim 6 wherein said current providing circuit further comprises a resonant circuit interconnected between said primary winding coil of said isolation transformer and said switching circuit.

9. The current-sharing supply circuit according to claim 8 wherein said resonant circuit includes a resonant capacitor and a resonant inductor, wherein said resonant capacitor and said resonant inductor are serially connected with said primary winding coil of said isolation transformer.

10. The current-sharing supply circuit according to claim 1 wherein each of said first output rectifier circuit and said second output rectifier circuit is a bridge rectifier circuit, a full-wave rectifier circuit or a half-wave rectifier circuit.

11. The current-sharing supply circuit according to claim 1 wherein each of said first set of main DC loads and said second set of main DC loads includes multiple light emitting diodes.

12. The current-sharing supply circuit according to claim 1 further comprising:
a first main output capacitor connected with said first set of main DC loads in parallel;
a first minor output capacitor connected with said first set of minor DC loads in parallel;
a second main output capacitor connected with said second set of main DC loads in parallel; and
a second minor output capacitor connected with said second set of minor DC loads in parallel.

13. The current-sharing supply circuit according to claim 1 further comprising:
a first minor current-sharing circuit serially connected with said first main current loop and said first minor current loop, respectively; and
a second minor current-sharing circuit serially connected with said second main current loop and said second minor current loop, respectively.

14. The current-sharing supply circuit according to claim 13 wherein a serial equivalent impedance value of said first main current-sharing circuit and said first minor current-sharing circuit is greater than an equivalent impedance value of each of said first set of main DC loads and said first set of minor DC loads, and a serial equivalent impedance value of said second main current-sharing circuit and said second minor current-sharing circuit is greater than an equivalent impedance value of each of said second set of main DC loads and said second set of minor DC loads.

15. The current-sharing supply circuit according to claim 13 wherein a sum of equivalent impedance values in said first main current loop, a sum of equivalent impedance values in said first minor current loop, a sum of equivalent impedance values in said second main current loop and a sum of equivalent impedance values in said second minor current loop are substantially identical, thereby achieving a current-balancing effect.

16. The current-sharing supply circuit according to claim 13 wherein each of said first minor current-sharing circuit and said second minor current-sharing circuit comprises a capacitive passive element.

17. The current-sharing supply circuit according to claim 16 wherein said first minor current-sharing circuit and said second minor current-sharing circuit comprises a first minor capacitor and a second minor capacitor, respectively.

18. The current-sharing supply circuit according to claim 13 wherein each of said first minor current-sharing circuit and said second minor current-sharing circuit comprises an inductive passive element.

19. The current-sharing supply circuit according to claim 1 wherein said first output rectifier circuit comprises a first main diode and a first minor diode, wherein an anode of said first main diode is connected with a cathode of said first minor diode, or a cathode of said first main diode is connected with an anode of said first minor diode.

20. The current-sharing supply circuit according to claim 19 wherein said first main diode is serially connected with said first set of main DC loads, and said first minor diode is serially connected with said first set of minor DC loads.

21. The current-sharing supply circuit according to claim 1 wherein said second output rectifier circuit comprises a second main diode and a second minor diode, wherein an anode of said second main diode is connected with a cathode of said second minor diode, or a cathode of said second main diode is connected with an anode of said second minor diode.

22. The current-sharing supply circuit according to claim 21 wherein said second main diode is serially connected with said second set of main DC loads, and said second minor diode is serially connected with said second set of minor DC loads.

23. The current-sharing supply circuit according to claim 1 wherein an equivalent impedance value of said first main current-sharing circuit is greater than an equivalent impedance value of each of said first set of main DC loads and said first set of minor DC loads, and an equivalent impedance value of said second main current-sharing circuit is greater than an equivalent impedance value of each of said second set of main DC loads and said second set of minor DC loads.
